(19) United States
(12) Patent Application Publication
(10) Pub. No.: US 2016/0251116 A1
(43) Pub. Date: Sep. 1, 2016

(54) LABELED HOLLOW FORMED CONTAINER AND FORMING METHOD THEREOF

(71) Applicant: YUPO CORPORATION, Tokyo (JP)

(72) Inventors: Takashi FUNATO, Tokyo (JP); Takahiko UEDA, Tokyo (JP); Yuuichi IWASE, Tokyo (JP)

(73) Assignee: YUPO CORPORATION, Tokyo (JP)

(21) Appl. No.: 14/911,837

(22) PCT Filed: Aug. 12, 2014
(86) PCT No.: PCT/CN2014/084151

§ 371 Date: May 12, 2016

(30) Foreign Application Priority Data
Aug. 13, 2013 (CN) 201310351549.0

(51) Int. Cl. B65D 23/08; B29C 49/24

(52) U.S. Cl. CPC B65D 23/0864; B29C 49/2408; B29K 2101/12

(57) ABSTRACT

A labeled hollow molded container and molding method thereof are disclosed. The container presents good impact resistance when falling down. The main body wall thickness variable X of the container section, which is calculated from the optical microscopic observation, meets the following formula (1), −50≦X<T . . . formula (1), the main body wall thickness variable (μm): X=Z−Y, the label thickness at the labeled part: T, the container thickness at the labeled part: Y, the container thickness at the unlabeled part: Z.

### TECHNICAL FIELD

The present disclosure relates to a labeled hollow molded container and preparation method thereof.

Particularly relates to a labeled hollow molded container with favorable impact resistance, and preparation method thereof.

### BACKGROUND ART

In order to hold a variety of liquids (such as edible oil, liquid seasonings, drinks, alcohols, kitchen cleaners, laundry detergents, shampoo, hair styling agents, liquid soap, alcohol for disinfection, oil for automobile, detergents for automobile, agricultural chemicals, pesticides, herbicides, etc.), and to circulate, exhibit, purchase, store and use such liquids, hollow molded containers with various sizes and shapes have always been used.

As a method for displaying a label at the outer peripheral surface, a blank label (a label on which no information is displayed) or a label displaying information (hereinafter both are referred to as “a label”) is inserted into the mold in advance, then a resin formed article such as a container is formed in the mold through injection molding, hollow molding, differential pressure molding, foam molding and the like. It was formed into a resin formed article which is integrated with a label, i.e. a hollow molded container with label. At this point, the general structure of the label used is such a structure that, printing is applied on the surface at one side of the substrate, while an adhesive layer is provided at the other side of the substrate.

As the substrate of the label, paper, paperboard, unstretched film, stretched film, synthetic paper, aluminum deposited film and the like can be used. In addition, as the method for printing the label, gravure printing, offset printing, flexographic printing and the like can be performed. Furthermore, said substrate and said printing method can be appropriately combined for practical use.

Herein, for the use in liquid filling, a labeled hollow molded container formed by a hollow molded container with single or multiple layers, which is produced with thermoplastic resin such as polyethylene, polypropylene, polyester, polyamide and the like through blow molding process, can be suitably used.

However, the labeled hollow container in prior art has a label embedded in the main body of the container. Therefore, comparing with the thickness of the container at the unlabeled part, the thickness of the container at the labeled part becomes extremely thin. Furthermore, due to the difference between the shrinkage ratio of the label and that of said thermoplastic resin in the cooling process immediately after the molding of the labeled hollow molded container, notches are formed at the label boundary portion of the labeled hollow molded container. For these reasons, there is a problem that the impact resistance of the labeled hollow molded container is poor, for example when a labeled hollow molded container in a content-filled state falls, such container is susceptible to breakage. In addition, when the labeled hollow molded containers filled with content are loaded into corrugated cardboard boxes, then shipped in a state that the corrugated cardboard boxes are stacked as several layers, there is a problem that the labeled hollow molded container is susceptible to breakage when they are shocked during shipping. The reason for these problems is that, the labeled hollow molded container breaks along the label boundary of the container; and the larger the internal volume is, the thinner the container thickness of the labeled hollow molded container is, or the thicker the thickness of the label is, the more significant the problems become.

As methods for improving the impact resistance of the labeled hollow molded container, the following methods are proposed: a method that a rib portion is provided outside the main body of the container along the boundary of the label (e.g. with reference to Patent Literature 1, 2); a method that the tensile modulus of the label or the thickness of the label is reduced (e.g. with reference to Patent Literature 3); a method that the end face of the label is chamfered (e.g. with reference to Patent Literature 4, 5); a method that a thermoplastic resin composition which contains a resin having memory effect (ME) within a certain range is used to increase the angle of the recess between the labeled part and the surface of the container (e.g. with reference to Patent Literature 6, 7), and so on.

### PRIOR ART LITERATURE

### Patent Literature

Patent Literature 1: Japanese Patent Laid-Open No. 2000-247334

Patent Literature 2: Japanese Patent Laid-Open No. 2002-179041

Patent Literature 3: Japanese Patent Laid-Open No. 2012-180096

Patent Literature 4: Japanese Patent Laid-Open No. 2001-39427

Patent Literature 5: Japanese Patent Laid-Open No. Hei8-142171

Patent Literature 6: Japanese Patent Laid-Open No. Hei7-100906

Patent Literature 7: Japanese Patent Laid-Open No. 2002-52601

### SUMMARY

### Technical Problems

However, in the method that a rib portion is provided outside the main body of the container along the boundary of the label, the design of the appearance of the container is limited. Furthermore, in the method that the tensile modulus of the label or the thickness of the label is reduced, if the size of the container is large, the load when the container falls increases, therefore the effect in improving impact resistance is not remarkable. Furthermore, when the label is loaded (inserted) in to the mold, there is a problem that the label bends or the label dropsoff from the mold, thus the productivity is decreased. Furthermore, in the method that the end face of the label is chamfered, a chamfering process in industrial manufacture has not been established. Furthermore, in the method that a thermoplastic resin composition which contains a resin having memory effect (ME) within a certain range is used to increase the angle of the recess between the labeled part and the surface of the container, in the instance that a label with a large thickness is bonded, the recess between the labeled part and the surface of the container is large, thus the impact resistance cannot be improved.

The target of the present disclosure is to solve the problems indicated above, and to provide a labeled hollow molded container with favorable impact resistance, and preparation method thereof.

### Solution to the Problems

In consideration of the target above, the inventors find that, if X satisfies the following formula (1), where X is the variation of the wall thickness of the main body of the cross section of the labeled hollow molded container, determined from the observation through optical electron microscope, then the impact resistance of the container may increase, so that the solution is achieved.

The first embodiment of the present disclosure relates to a labeled hollow molded container, wherein, the container is formed with thermoplastic resin composition, and X satisfies the following formula (1), and the value of X is 90 or less, where X is the variation of the wall thickness of the main body of the cross section of the labeled hollow molded container, determined from the observation through optical microscope,

−50≦X<T formula (1)

the variation of the wall thickness of the main body: X=Z−Y

thickness of the label at the labeled part: T

thickness of the container at the labeled part: Y

thickness of the container at the unlabeled part: Z,

unit of X, Y, Z, T: μm.

The second embodiment of the present disclosure relates to a method for molding a labeled hollow container, wherein, the mold has a label inserting section, said label inserting section has such a structure that is able to provide a label loading recess which fits the shape of the label; a label is inserted into the label inserting section of the mold, then a thermoplastic resin composition in a moldable state is introduced into the mold to perform the container molding process.

That is, the present disclosure includes the following aspects.

[1] A labeled hollow molded container, wherein, the labeled hollow molded container includes a label and a hollow molded container,

the container is formed with thermoplastic resin composition,

X satisfies the following formula (1), and the value of X is 90 or less, where X is the variation of the wall thickness of the main body of the cross section of the labeled hollow molded container, determined from the observation through optical microscope,

−50≦X<T formula (1)

the variation of the wall thickness of the main body: X=Z−Y

thickness of the label at the labeled part: T

thickness of the container at the labeled part: Y

thickness of the container at the unlabeled part: Z,

unit of X, Y, Z, T: μm.

[2] The labeled hollow molded container according to [1], wherein, the label has a compression ratio c of 30% or more and 60% or less at a pressure of 3.138 MPa.

[3] The labeled hollow molded container according to [1] or [2], wherein, the labeled hollow molded container is formed using a mold with label inserting section, said label inserting section has such a structure that is able to provide a label loading recess which fits the shape of the label.

[4] The labeled hollow molded container according to any one of items [1] to [3], wherein, the hollow molded container is a hollow molded container which is obtained through a method that a label is integrated simultaneously with blow molding.

[5] The labeled hollow molded container according to any one of items [1] to [4], wherein, the thermoplastic resin composition comprises a polyolefin resin composition.

[6] A method for molding a labeled hollow container, wherein, the mold has a label inserting section, said label inserting section has such a structure that is able to provide a label loading recess which fits the shape of the label; a label is inserted into the label inserting section of the mold, then a thermoplastic resin composition in a moldable state is introduced into the mold to perform the container molding process.

[7] The method for molding a labeled hollow container according to [6], wherein, d, which is the depth of the label loading recess, satisfies the following formula (2),

0<d≦t+50 formula (2)

depth of the label loading recess: d

thickness of the label: t,

unit of d, t: μm.

[8] The method for molding a labeled hollow container according to [6] or [7], wherein, the thermoplastic resin composition comprises a polyolefin resin composition.

### Advantageous Effects

According to the present disclosure, a labeled hollow molded container and preparation method thereof are provided, said labeled hollow molded container maintains the appearance design features, light weight property and productivity, and has an increased impact resistance; even though the size of the container increases, the container is not susceptible to breakage due to shocks like a fall, etc.

### BRIEF DESCRIPTION OF THE DRAWINGS

FIG. 1 is an example showing the cross section of the hollow molded container of the present disclosure.

FIG. 2 is another example showing the cross section of the hollow molded container of the present disclosure.

FIG. 3 is an example showing the state that the mold of the present disclosure is loaded with a label.

FIG. 4 is an example showing the cross section of the mold of the present disclosure in a state that the mold is used in molding a container.

FIG. 5 is an example showing the cross section of a mold in prior art in a state that the mold is used in molding a container.

FIG. 6 shows a fixture for determining the compression ratio in the Example.

### LIST OF REFERENCE NUMBERS USED IN THE DRAWINGS

1: cross section of the label
2: cross section of the hollow molded container
3: label
4: mold
5: label loading recess
6: chamber
7: suction hole
8: sample to be measured
9: stand for experiment
10: sample stage
11: laser displacement sensor
12: fixture for clamping the sample
13: laser
14: load sensor
15: metal ball
1a: boundary of the label
2a: the position to collect the sample for measurement

### DESCRIPTION OF THE EMBODIMENTS

Hereinafter the present disclosure will be described in detail. The specification of the technical features described below is an example (representative example) of the embodiment of the present disclosure, while the present application is not limited to the disclosure.

Furthermore, in the present disclosure, if recorded as “˜”, it refers to a range that includes the values before and after it, as minimal and maximal value respectively.

Furthermore, in the present disclosure, if indicated as “(meth)acrylic acid”, it includes both acrylic acid and methacrylic acid.

Furthermore, in the present disclosure, if indicated as “main component”, it refers to the component with highest amount by mass among all the components included in the subject composition.

<Labeled Hollow Molded Container>

The labeled hollow molded container of the present disclosure is wherein, the container is formed with thermoplastic resin composition; X satisfies the following formula (1), and the value of X is 90 or less, where X is the variation of the wall thickness of the main body of the cross section of the labeled hollow molded container, determined from the observation through optical microscope,

−50≦X<T formula (1)

the variation of the wall thickness of the main body: X=Z−Y

thickness of the label at the labeled part: T

thickness of the container at the labeled part: Y

thickness of the container at the unlabeled part: Z

unit of X, Y, Z, T: μm.

In the present disclosure, the “labeled hollow molded container” refers an object which comprises a label and a resin formed article with hollow part. The shape of the resin formed article can be cup-like, bottle-like and so on, and molding method thereof includes injection molding, direct blow molding, stretch blow molding, pressure molding, etc.

(Variation of the Wall Thickness of the Main Body)

From the viewpoint that the labeled hollow molded container is readily taken out from the mold, the variation of the wall thickness of the main body, X, is −50 μm or more, preferably −20 μm or more, more preferably 0 μm or more. In addition, from the viewpoint of the container breakage caused by the stress concentrated at the edge of the label when the container falls, the foregoing X preferably has a value of 90 μm or less, preferably 60 μm or less, more preferably 40 μm or less.

On the other hand, from the viewpoint that the thickness of the container at the labeled part will not become extremely thin, comparing with the thickness of the container at the unlabeled part, if the thickness of the label at the labeled part is defined as Tμm, then the value of foregoing X is less than T μm, preferably T/2 μm or less, more preferably T/3 μm or less.

The measurement of T, the thickness of the label at the labeled part; Y, the thickness of the container at the labeled part; and Z, the thickness of the container at the unlabeled part; is performed through observation of the cross section with optical microscope, and image processing.

The sample to be measured is obtained with the following process: in a labeled hollow molded container, the main body of the container is cut off at any position where the boundary of the label is included, and chilled to a temperature of −60° C. or lower with liquid nitrogen. A razor blade is subject to perpendicularly contact with the specimen placed on a glass plate, and cut the specimen off, so that the sample for measuring the cross section is prepared. The cross section indicated above is observed with any magnification (for example, the sample is magnified 50 times˜500 times), so long as the sample can be readily observed with optical microscope. Further, the observed area is introduced into a computer in the form of image.

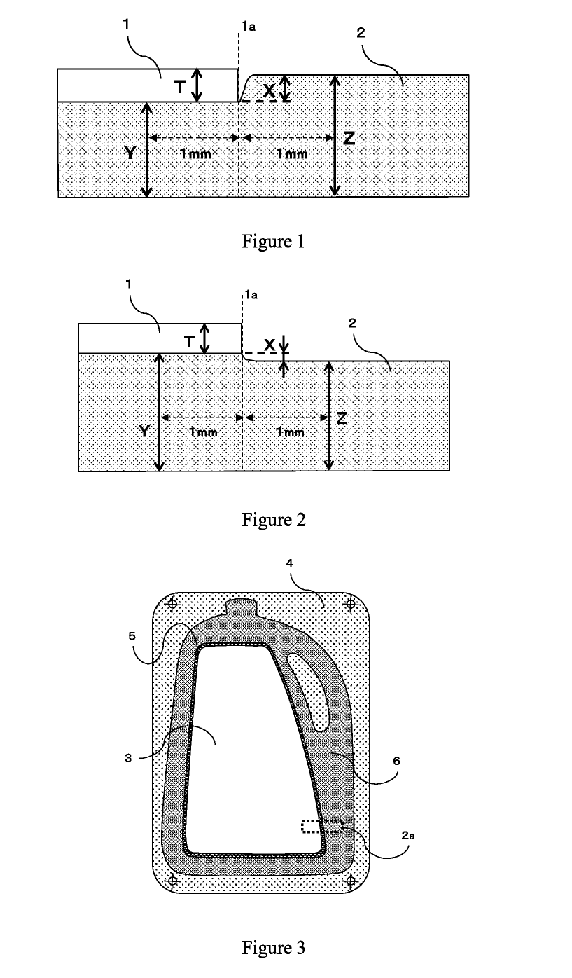

For image processing, the thickness of the container at the parts shown in FIG. 1 and FIG. 2 are determined on the computer, and the thickness of the label at labeled part (T), the thickness of the container at the labeled part (Y), and the thickness of the container at the unlabeled part (Z) are determined.

It should be further explained that, the thickness of the label at the labeled part (T) and the thickness of the container at the labeled part (Y), as shown in FIG. 1 and FIG. 2, are measured at the position 1±0.05 mm inward the outer edge of the label along the surface of the label at the cross section indicated above. Further, the thickness of the container at the unlabeled part is similarly measured at the position outward 1±0.05 mm outward the outer edge of the label along the surface of the label at the cross section indicated above.

In addition, in the measurement method, the thickness of adhesive layer (B) is not included in the thickness of the label (T). The reason is, when molding the labeled hollow molded container, the thermoplastic resin that constitutes the adhesive layer (B) melts, and integrates with the material of the hollow molded container, i.e., thermoplastic resin, and the boundary is not clear.

Preferably, the labeled hollow molded container of the present disclosure is formed using the following mold: said mold has a label inserting section, and said label inserting section has such a structure that is able to provide a label loading recess which fits the shape of the label.

Furthermore, preferably, the labeled hollow molded container is formed in such a way that, the label is integrated simultaneously with blow molding.

(Impact Resistance)

The labeled hollow molded container of the present disclosure has favorable impact resistance, and there is a tendency that even in a content-filled state, the container, when falls, is not susceptible to breakage. Further, even the labeled hollow molded container filled with content is loaded into corrugated cardboard boxes for shipping, then shipped in a state that the corrugated cardboard boxes are stacked as several layers, there is also a tendency that the labeled hollow molded container is not susceptible to breakage.

<Mold>

The mold used in molding the hollow molded container of the present disclosure preferably has a label inserting section; said label inserting section has such a structure that is able to provide a label loading recess which fits the shape of the label.

Here, the label loading recess which “fits the shape of the label” means that, the label can be accommodated in the recess portion provided in the mold, but not protrude from the recess portion. The label loading recess and the label do not necessarily have the same shape.

In addition, d, which is the depth of the label loading recess as indicated above, preferably satisfies the following formula (2).

0<d≦t+50 formula (2)

depth of the label loading recess: d

thickness of the label: t,

unit of d, t: μm.

From the viewpoint to improve the impact resistance of the labeled hollow molded container, d, which is the depth of the label loading recess as indicated above, is preferably 10 μm or more, more preferably 40 μm or more. On the other hand, from the viewpoint that the mold preparation is easy, and that the labeled hollow molded container is readily to be taken out from the mold, the depth d is preferably 200 μm or less, more preferably 150 μm or less.

The mold preferably used in molding the hollow molded container of the present disclosure, as indicated above, has a label loading recess; the depth of the gap, d, is an intentional value that is not zero. Therefore, in the labeled hollow molded container obtained through the use of the mold, the label shows such a shape that, it protrude from the surface of the container at the unlabeled part, as shown in FIG. 1, 2. In formula (1), there is an relationship that X<T.

(Preparation Method of the Mold)

Except for providing the label loading recess, the mold indicated above can be prepared with well-known method in the art.

The method for providing the label loading recess in the mold indicated above is not particularly limited, for example, it can be provided through directly engraving a label loading recess with a depth of d on the mold; it can also be provided in such a way that, the part which is equivalent to the loading recess is separated as a nest, and the nest recedes from the chamber surface of the mold with a distance of d, i.e., the depth of the label loading recess.

In addition, in order to perform vacuum suction on the label when label is loaded to make tight adhesion of the label, a suction hole 7 can be provided on the mold of the present disclosure. In case of a mold of nest forms, the interval between the nests each other or the interval between the nest and the main body of the mold can be set relatively wide as a gap. From the viewpoint to ensure the air mass flow of vacuum suction, the diameter of the suction hole and/or the width of the gap is preferably 1 mm or more, more preferably 2 mm or more. On the other hand, if the suction hole and/or gap has a shape that leaves a mark on the surface of the label, then the appearance of the article is impaired. Therefore the diameter of the suction hole and/or the width of the gap is preferably 10 mm or less, more preferably 5 mm or less.

<Label>

The label used in the present disclosure at least comprises substrate (A) and an adhesive layer (B), and has a structure with at least two layers, where the adhesive layer (B) is laminated on one side of the substrate (A). It can be formed with any material, has any constitution, prepared in any method, as long as when the label is inserted into the mold, and a thermoplastic resin composition in molten state is introduced into the mold, the labeled hollow molded container of the present disclosure can be formed.

(Layered Structure)

The substrate (A) of the label may be a single-layer structure, or it may also be a multi-layer structure with two or more layers. In addition, at the side of the substrate (A) that is not in contact with adhesive layer (B), printed information can be applied. It should be noted that, when applying printed information, a recording layer (C) suitable for printing can be provided on the surface of the substrate (A) at the side that is not in contact with adhesive layer (B), and the printed information is applied via the recording layer (C).

(Thickness of the Label)

From the viewpoint that the label, when inserted into the mold with a label insert instrument, can be easily fixed at the accurate position, or wrinkle is not easy to occur on the label, t, which is the thickness of the label used in the present disclosure, is preferably 20 μm or more, more preferably 40 μm or more, further preferably 60 μm or more. On the other hand, from the viewpoint that an air pocket, or a thin-wall part will not be produced between the label and the hollow molded container, so that the strength of falling resistance of the formed article is improved, or to reduce the processing cost of the mold, t is preferably 250 μm or less, more preferably 200 μm or less, further preferably 150 μm or less.

It should be noted that, t, the thickness of the label, is measured mechanically with a micrometer, based on method A in JIS K 7130:1999 (“Method for measuring the thickness of plastic-film and sheet”).

It should be noted that T, which is the thickness of the label at the labeled part, is usually smaller than the value of label thickness t in formula (2). The reasons are, the label preferably has voids in its inner part; when the molten resin is pressed to contact with the adhesive face of the label during the formation of the labeled hollow molded container, the label is compressed along the direction of thickness. In addition, it can be exemplified that label thickness t in formula (2) is measured as an integral thickness of the label including the thickness of adhesive layer (B); while the adhesive layer (B) of the label melts, mixes with the thermoplastic resin composition of the hollow molded container and integrates, so in T, i.e., the label thickness at the labeled part in formula (1), the thickness of the adhesive layer (B) is not considered.

(Compression Ratio of the Label)

In order to further decrease X, i.e., variation of the wall thickness of the main body, the compression ratio (c) of the label at the pressure of 3.138 Mpa determined with the method for measuring compression ratio described below, is preferably 30% or more, more preferably 45% or more. On the other hand, from the viewpoint to keep the durability of the label surface, the compression ratio (c) is preferably 60% or less, more preferably 55% or less.

When the thermoplastic resin composition which constitutes the hollow molded container of the present disclosure is introduced into the mold and molded into a container, the backward pressure of the resin becomes compression force, and the label is fixed in a state that is compressed along the direction of thickness. Therefore, when the compression ratio (c) is higher than the lower limit indicated above, it may make the variation of the wall thickness of the main body (X) small. Then when the labeled hollow molded container is taken out from the mold, the compression force of the label as indicated above is released, so the label expands towards the direction of thickness. Therefore, a container in the state that the label surface protrudes from the surface of the hollow molded container (that is, X<Y) can be obtained.

The method for determining the compression ratio (c) of the label at the pressure of 3.138 MPa is that, with the measure instrument as shown in FIG. 6, the initial film thickness (e) at the time that the compression stress is 0, and the pressurized film thickness (f) at the time that the compression stress of the film surface is 3.138 MPa (32 kgf/cm²) are measured, and the compression ratio (c) is calculated according to the following formula. Measurement of film thickness e and f is performed using CCD laser displacement sensor.

compression ratio c=100×(e−f)/e formula (3)

unit of c: %,

unit of e, f: μm.

(Surface Roughness of the Label)

The surface roughness of the label, which originates from the size of the convex and the concave at the surface, is calculated as follows: the label surface is measured with a probe-type surface roughness analyzer as defined in JIS B 0633:2001 (“Geometrical Product Specifications (GPS)—surface structure: outline method—rules and procedure for evaluating surface characters”), and the arithmetic average roughness Ra, as defined in JIS B 0601:2001 (“Geometrical Product Specifications (GPS)—surface structure: outline method—terms, definitions and surface structure parameters”), is determined.

Through having the convex and the concave with appropriate size at the surface of adhesive layer (B) of the label, when the label is mounted to the mold, the air encapsulated between the label and the container can be rapidly exhausted to the outside via the concave, so that to inhibit the generation of bubble (the bulge on the label) during the formation of labeled hollow molded container.

From the viewpoint of inhibiting bubble, the arithmetic average roughness Ra of the surface of the adhesive layer (B) of the label is preferably 0.5 μm or more, more preferably 1.5 μm or more. On the other hand, from the viewpoint to keep a good appearance of the surface of the labeled hollow molded container, the roughness Ra is preferably 10 μm or less, more preferably 5 μm or less.

For the method to make arithmetic average roughness Ra of the surface of the adhesive layer (B) of the label falls within the range indicated above, it may exemplify: during or after the molding of the adhesive layer (B), a shape is provided by an embossing roller, and so on.

On the other hand, through having the convex and the concave with appropriate size at the surface of the label at the side opposite to the adhesive layer (B), the printability of the surface can be improved. From the viewpoint of making favorable adhesiveness of the ink, the arithmetic average roughness Ra of the surface of the label at the side opposite to the adhesive layer is preferably 0.15 μm or more, more preferably 0.2 μm or more. On the other hand, from the viewpoint to inhibit the appearance defect caused by roughness of the surface, the roughness Ra is preferably 2 μm or less, more preferably 1 μm or less.

For the method to make the arithmetic average roughness Ra of the surface of the label at the site opposite to the adhesive layer falls within the range indicated above, it may exemplify: a method to blend inorganic fine particles into substrate (A) and stretch, so as to make microvoids on the surface, or a method to provide a recording layer (C) as described later on the surface of the substrate (A) at the side that not contact to the adhesive layer (B), etc.

(Friction Coefficient of the Label)

When molding the hollow molded container, in order to stably perform the insertion of the label into the mold, it is preferred that, under a circumstance that the labels stack, in two adjacent labels, the static friction coefficient between the adhesive layer (B) of one of the label and the surface of the other label at the side opposite to the adhesive layer (B) is low. In the present disclosure, the static friction coefficient and dynamic friction coefficient of the label can be determined based on JIS K 7125:1999 (“Test method for friction coefficient of plastic-film and sheet-”).

The static friction coefficient indicated above is preferably in the range of 0.55˜1.0, more preferably in the range of 0.7˜0.9. By making the static friction coefficient be 0.55 or more, there is a tendency that label drop trouble caused by excessive smoothness of the label is inhibited. On the other hand, by making the static friction coefficient be 1.0 or less, there is a tendency that the separation between the labels is favorable, and the trouble of feeding two labels simultaneously into the mold is inhibited.

In addition, in a circumstance that the labels stack, in two adjacent labels, the dynamic friction coefficient between the adhesive layer (B) of one of the label and the surface of the other label at the side opposite to the adhesive layer (B) is preferably in the range of 0.3˜1.0, more preferably in the range of 0.4˜0.9.

For the method to control the static friction coefficient or dynamic friction coefficient of the label within the range indicated above, it may exemplify: a method through setting the surface roughness of the surface of adhesive layer (B) and the surface at the opposite side of the label within the range indicated above, so as to directly reduce the friction; and, a method through providing at least one surface of the outmost surfaces of the label with antistatic function, so as to inhibit the adsorption caused by static electricity. Preferably the two methods above are used in combination.

(Printability of the Label)

To the label that may be used in the present disclosure, printability can be provide on the surface of the label at the side opposite to the adhesive layer (B) through various means.

As the methods, surface oxidation treatment may be applied on the surface of the substrate (A) at the side opposite to the adhesive layer (B), or coating treatment may also be applied to provide a recording layer (C). Preferably the two methods above are used in combination.

As the surface oxidation treatment methods, it may exemplify one or more methods selected from corona discharge treatment, flame treatment, plasma treatment, glow discharge treatment, ozone treatment, and the like. Among these, corona discharge treatment is preferred. In the circumstance of corona discharge treatment, from the viewpoint of stability and performing effective treatment, the treating throughput is preferably 10˜200 W·min/m² (600˜12,000 J/m²), more preferably 20˜180 W·min/m² (1,200˜10,800 J/m²).

As the method for providing recording layer (C), it may exemplify a method that a surface treatment liquid which at least contains an antistatic agent and a macromolecular binder is coated, and drying is performed if necessary, so that a recording layer (C) is produced. The recording layer (C) obtained through such operation preferably comprises 1˜99 mass % of antistatic agent, and 99˜1 mass % of macromolecular binder, and 0˜25 mass % of pigment particles.

As the antistatic agent, it may exemplify organic compounds with low-molecular weight, as represented by stearic acid monoglyceride, alkyl diethanolamine, sorbitan monolaurate, alkyl benzene sulfonate, alkyl diphenyl ether sulfonate; polymers with antistatic function, as represented by the following substances: non-ionic polymer type antistatic agents like polyethylene glycol, polyoxyethylenediamine, etc., quaternary ammonium salt type copolymer like polyvinylbenzyltrimethyl ammonium chloride, poly(dimethylaminoethyl (meth)acrylate) quaternary ammonium salt, etc., alkali metal salt-containing polymers obtained from adding alkali metal ion addictives and the like to polymers comprising alkyleneoxy and/or hydroxy group.

Among these, quaternary ammonium salt type copolymer has favorable antistatic performance, and the effect on antistatic performance due to environmental humidity is small, therefore it is preferred.

From the viewpoint of showing antistatic performance, the content of antistatic agent in the recording layer (C) is preferably 5 mass % or more, more preferably 10 mass % or more, based on the solid components. On the other hand, from the viewpoint of transfer property and adhesiveness of the printing ink, the content is preferably 75 mass % or less, more preferably 50 mass % or less, based on the solid components.

As the polymer binders, it may exemplify polyethylene imine polymers like polyethylene imine, alkyl modified polyethylene imine with carbon atom number of 1˜12, poly(ethylene imine-urea), ethylene imine adduct of poly(ethylene imineurea), polyamine polyamide, ethylene imine adduct of polyamine polyamide and epichlorohydrin adduct of polyamine polyamide, etc.; acrylate polymers like acrylate copolymer, methacrylate copolymer, acrylamide-acrylate copolymer, acrylamide-acrylate-methacrylate copolymer, polyacrylamide derivative and oxazolinyl-containing acrylate polymers; polyvinylpyrrolidone, polyethylene glycol, vinyl acetate resin, urethane resin, polyether resin, polyester resin, urea resin, terpene resin, petroleum resin, ethylene-vinyl acetate copolymer, vinyl chloride resin, vinyl chloride-vinyl acetate copolymer resin, vinylidene chloride resin, vinyl chloride-vinylidene chloride copolymer resin, chlorine-substituted ethylene resin, chlorine-substituted propylene resin, butyral resins, silicone resins, nitrocellulose resins, styrene-acrylic copolymer resin, styrene-butadiene copolymer resin, and acrylonitrile-butadiene copolymer, etc.

From the viewpoint of improving the adhesiveness of the printing ink, the content of the macromolecular binder in the recording layer (C), converted based on the solid components, is preferably 10 mass % or more, more preferably 20 mass % or more. On the other hand, from the viewpoint of readily preventing the labels from blocking, the concent, converted based on solid components, is preferably 75 mass % or less, more preferably 50 mass % or less.

The recording layer (C) of the label may further comprise pigment particles if necessary. For the pigment particles, considering that oil-absorbing property thereof may improve the fixability of the printing ink, as an extender pigment to improve the texture/gloss of the surface, as a white pigment to improve whiteness, to provide surface unevenness to improve anti-blocking performance, as a ultraviolet reflect material to provide functions like improve light resistance and weather resistance, etc., it may be suitably selected and used.

As the pigment particles, organic compounds, fine powder of the organic compounds can be used, as the specific examples, silicon oxide, calcium carbonate, calcined clay, titanium oxide, zinc oxide, barium sulfate, diatomaceous earth, acrylic particles, styrene particles, polyethylene particles, polypropylene particles, etc. can be used.

The particle size of the pigment particles that can be comprised in the recording layer (C) of the label is represented by the volume average particle diameter determined by means of laser diffraction. From the viewpoint that the pigment particle is not likely to detach from the recording layer (C), the volume average particle diameter of the pigment particle is preferably 20 μm or less, more preferably 15 μm or less.

From the viewpoint that the contents of antistatic agent and macromolecular binder are relatively sufficient, the surface of the recording layer (C) is not likely to be charged, and the adhesiveness of the printing ink becomes higher, the content of the pigment particle in the recording layer (C) is preferably 0˜25 mass %, more preferably 0˜15 mass %, further preferably 0˜5 mass %.

The components indicated above can be dissolved in a simple solvent system or a mixed solvent system selected from water, methanol, ethanol, isopropanol, acetone, methyl ethyl ketone, ethyl acetate, toluene, xylene and the like, and used as a surface treatment agent in the state of a solution, or it may be dispersed and used as a surface treatment agent in the state of an emulsion or a dispersion. Among these, if it is used in the form of aqueous solution, then the process management is easy, so it is preferred. The concentration of the solution is generally 0.1˜20 mass %, preferably 0.2˜10 mass %.

As the method for coating the surface treatment agent, coating or dipping with a die coater, a roll coater, a gravure coater, a spray coater, a blade coater, a reverse coater, an air knife coater, a size press coater, etc., may be used.

Coating of the surface treatment agent may be carried out together with film forming in the production line for forming substrate (A) or labels, or carried out in another production line on substrate (A) or labels which are already formed. If necessary, the excess solvent is removed through drying procedure with oven or the like, to form the recording layer (C).

[Substrate (A)]

Substrate (A) functions as a support for the label. It is usually formed by paper, thermoplastic resin film, preferably thermoplastic resin film. Through forming the substrate by thermoplastic resin, a label with water resistance and superior property of shape following against the container can be formed.

In addition, the substrate (A) may have a single layer structure, or may have a multi-layer structure with two or more layers. Through making the substrate (A) into multi-layer structure, various functions such as recording property, printability, scratch resistance, secondary processing compatibility can be added.

Each layer that constitutes the substrate (A) may respectively be an unstretched layer, a uniaxially stretched layer, or a biaxially stretched layer.

[Thermoplastic Resin]

The type of the thermoplastic resin used in the substrate (A) is not particularly limited. For example, olefin resins that may be formed into film, such as high-density polyethylene, medium-density polyethylene, low-density polyethylene, polypropylene, propylene-based copolymer resins, polymethyl-1-pentene, ethylene-cyclic olefin copolymer and the like; styrene-based resins such as atactic polystyrene, syndiotactic polystyrene, styrene-maleic acid copolymer and the like; ester resins such as polyethylene terephthalate, polyethylene terephthalate/isophthalate, polybutylene terephthalate, and polybutylene succinate, polybutylene adipate, polylactic acid and the like; polyolefin resins containing functional groups, such as ethylene-vinyl acetate copolymer, ethylene-acrylic acid copolymer, maleic acid-modified polyethylene, maleic acid-modified polypropylene and the like; amide resins such as nylon 6, nylon-6,6 and the like; and polycarbonate. In these resins, one kind, or mixed two or more kinds can be used.

In these thermoplastic resin, from the viewpoint of superior processability of the film, olefin resins or olefin resins containing functional groups are preferably used, and olefin resins are more preferably used.

Further, among the olefin resins, from the viewpoint of chemical resistance, processability and low cost, high-density polyethylene, propylene-based resins are preferred. As the propylene-based resins, it may exemplify polypropylene, which is a homopolymer of propylene, and shows stereoregularity like isotactic, syndiotactic, atactic; polymers which is obtained from copolymerization of propylene (as main component) together with one or more α-olefins like ethylene, 1-butene, 1-hexene, 1-heptene, 1-octene, 4-methyl-1-pentene. Further, as copolymer, it may be a random copolymer or a block copolymer.

In addition, a material obtained through graft modification of the olefin resins or olefin resins containing functional groups may also be used. For the method of graft modification, it may exemplify that, to allow the reaction of unsaturated carboxylic acid or its derivatives in the presence of peracids or metal salts thereof, like peracetic acid, persulfuric acid, potassium persulfate etc.; and oxidants, such as ozone and the like.

The graft modification rate, relative to the olefin resins or olefin resins containing functional groups, is usually 0.005˜10 mass %, preferably 0.01˜5 mass %.

From the viewpoint of forming stability during manufacture of substrate (A), the substrate (A) preferably contains thermoplastic resin thermoplastic resin in an amount of 25 mass % or more, more preferably contains 45 mass % or more, more preferably contains 65 mass % or more. On the other hand, from the viewpoint of increasing the opacity, whiteness of the substrate (A), the substrate (A) preferably contains thermoplastic resin in an amount of 99 mass % or less, more preferably contains 95 mass % or less.

(Inorganic Fine Powder)

Preferably, the substrate (A) contains inorganic fine powder in addition to thermoplastic resin. Through having inorganic fine powder in substrate (A), the whiteness and opacity of the substrate (A) can be achieved, and the visibility of the printings provided on the label is improved.

The particle size of the inorganic fine powder is represented by volume average particle diameter determined with laser diffraction method. From the viewpoint of achieving whiteness and opacity of the substrate (A), the volume average particle diameter is generally 0.01 μm or more, preferably 0.1 μm or more. On the other hand, form the viewpoint of making favorable appearance of the label, the volume average particle diameter is generally 15 μm or less, preferably 5 μm or less.

As the type of inorganic fine powder used in the substrate (A), it may exemplify calcium carbonate, calcined clay, silica, diatomaceous earth, white clay, talc, titanium oxide, barium sulfate, alumina, zeolite, mica, sericite, bentonite, sepiolite, vermiculite, dolomite, wollastonite, glass fibers and the like. Among them, from the viewpoint of whitening, opacification and the moldability of the resin, calcium carbonate, talc, titanium oxide are preferred, and calcium carbonate, titanium oxide are more preferred.

The surface of the inorganic fine powders may be subjected to hydrophilic treatment or hydrophobic treatment in advance. Through these surface treatment, various properties like printability, compatibility for coating, scratch resistance, secondary processing compatibility can be provided to the substrate (A).

From the viewpoint of increasing the opacity and whiteness of the substrate (A), the substrate (A) preferably contains the inorganic fine powder in an amount of 1 mass % or more, more preferably contains 5 mass % or more. On the other hand, from the viewpoint of forming stability during manufacture of substrate (A), the substrate (A) preferably contains the inorganic fine powder in an amount of 75 mass % or less, more preferably contains 55 mass % or less, further preferably contains 35 mass % or less.

(Other Components)

In the present disclosure, if necessary, the substrate (A) may contain an organic filler, a thermostabilizer (antioxidant), a photostabilizer, a dispersant or a lubricant, etc.

When the substrate (A) contains an organic filler, from the viewpoint of exhibiting the function of the organic filler, it is preferably contained in an amount of 0.01 mass % or more. On the other hand, from the viewpoint of making favorable appearance of the label, it is preferably contained in an amount of 20 mass % or less, more preferably 10 mass % or less. As the organic filler, a type of resin that is different from the thermoplastic resin used as the main component of the substrate (A) is preferably selected. Among these, a resin with melting point or glass transition temperature higher than those of the thermoplastic resin used as the main component of the substrate (A) is preferably selected. For example, if the thermoplastic resin, as the main component of substrate (A), is a polyolefin resin (with melting point of 80˜160° C.), then the melting point of the organic filler is preferably 170˜300° C., and the glass transition temperature of the organic filler is preferably 170˜280° C. As the organic filler exhibiting such melting point or glass transition temperature, it may exemplify polyethylene terephthalate, polybutylene terephthalate, polycarbonate, nylon-6, nylon-6,6, and the like.

On the other hand, it is more preferable to select a thermoplastic resin incompatible with the thermoplastic resin which is the main component of substrate (A). If the thermoplastic resin as the main component of substrate (A) is a polyolefin resin, then as the organic filler, except for those resins listed above, it may further exemplify polystyrene, polymethyl methacrylate and the like. If the thermoplastic resin as the main component of substrate (A) is a propylene-based resin, then as the organic filler, except for those resins listed above, it may further exemplify high-density polyethylene, low-density polyethylene, cyclic polyolefin and the like.

In case that the substrate (A) contains a thermostabilizer, from the viewpoint of exhibiting the function of the thermostabilizer, the thermostabilizer is preferably contained in an amount of 0.001 mass % or more. On the other hand, from the viewpoint of making favorable appearance of the labels and economic efficiency, the thermostabilizer is preferably contained in an amount of 1 mass % or less, more preferably 0.5 mass % or less.

As the thermostabilizer, one or two or more selected from the well-known thermostabilizers (antioxidants) like the hindered phenol-based, phosphorus-based, amine-based ones may be suitably used.

In case that the substrate (A) contains a photostabilizer, from the viewpoint of exhibiting the function of the photostabilizer, the photostabilizer is preferably contained in an amount of 0.001 mass % or more. On the other hand, from the viewpoint of making favorable appearance of the labels and economic efficiency, the photostabilizer is preferably contained in an amount of 1 mass % or less, more preferably 0.5 mass % or less.

As the photostabilizer, one or two or more selected from the well-known photostabilizer like the hindered phenol-based, benzotriazole-based, benzophenone-based ones may be suitably used.

In addition, it is preferable to use the photostabilizer and thermostabilizer above in combination.

When the substrate (A) contains a dispersant or a lubricant, from the viewpoint of exhibiting the function of dispersant or lubricant, the dispersant or lubricant is preferably contained in an amount of 0.01 mass % or more. On the other hand, from the viewpoint of making favorable forming property and printing compatibility of the labels, the dispersant or lubricant is preferably contained in an amount of 4 mass % or less, more preferably 2 mass % or less.

As the dispersant or a lubricant, one or two or more selected from the well-known silane coupling agent; fatty acids with carbon atom number of 8˜24 like oleic acid, stearic acid, etc., and metal salts, amides, esters that is formed with an alcohol with carbon atom number of 1˜6 thereof and the like; poly(meth)acrylic acid and metal salt thereof.

(Forming of the Substrate (A))

The method for forming the substrate (A) as thermoplastic resin film is not particularly limited, and various methods known in the art may be used.

As the specific examples, it may exemplify: a cast molding method, where the thermoplastic resin composition that constitutes the substrate (A) is melt-kneaded using a screw-type extruder, and extruded into a sheet using a T-die connected to the extruder, and pressed to a cooling roll for cooling; a blow molding method, where the molten resin is extruded as tubes using a circular die connected to the extruder, and forced to expand with the air pressure inside the tube; a calendar molding method, where the molten-kneaded thermoplastic resin composition is extended by a plurality of heat rolls, and processed into a sheet; a rolling molding method, etc.

When stretching the substrate (A) and any layer constituting the substrate (A), the stretching method is not particularly limited, and various methods known in the art can be used. As the stretching method, if a cast molded film is stretched, it may exemplify methods like: a longitudinally stretching method, where the peripheral speed difference between a set of rolls is utilized; a transversely stretching method, where a tenter oven is used; a rolling method; a synchronized biaxial stretching method, where a combination of a tenter oven and a linear motor is utilized; a simultaneous biaxial stretching method, where a tenter oven and a pantograph are utilized; etc. In addition, if an inflation film is stretched, it may exemplify a simultaneous biaxial stretching method based on tubular method.

Further, when the substrate (A) presents a multilayer structure, as a preferable forming example, it may exemplify a method that, one of the layer is subjected to cast molding as indicated above, and after stretched (if necessary) using the peripheral speed difference of the rolls, the resin composition constituting the other layers of the substrate (A) is melted and laminated, then a multilayer structure is produced. On the other hand, as a preferable forming example, it may further exemplify a method that, several kinds of resin compositions are laminated inside the T-mold indicated above, and co-extruded from the T-mold and molded, so that a multilayer structure is produced. In addition, these methods may also be suitably used in combination.

The condition for stretching substrate (A) is not particularly limited; it is appropriately determined in consideration of the characteristics of the thermoplastic resin to be used. For example, for the stretch ratio, when propylene homopolymer or copolymer thereof is used as the thermoplastic resin, then if stretched unidirectionally, the ratio is 1.2˜12 times, preferably 2˜10 times; and if stretched biaxially, the ratio is 1.5˜60 times, preferably 4˜50 times, based on area ratio. When other thermoplastic resin is used, then if stretched unidirectionally, the ratio is 1.2˜10 times, preferably 2˜5 times; and if stretched biaxially, the ratio is 1.5˜20 times, preferably 4˜12 times, based on area ratio.

Further, the stretching temperature can be selected from a well-known temperature range suitable for stretching the thermoplastic resin, which is between the glass transition temperature of the thermoplastic resin used and the melting point of the crystal part. Specifically, the stretching temperature is 100˜164° C. in case the thermoplastic resin is a propylene homopolymer (melting point 155˜167° C.), and the stretching temperature is 70˜133° C. in case the thermoplastic resin is high-density polyethylene (melting point 121˜134° C.), which is 1˜70° C. lower than the melting point. In addition, for polyethylene terephthalate (melting point 246˜252° C.), a temperature at which crystallization does not proceed rapidly is selected. In addition, the stretching speed is preferably set at 20˜350 m/min.

It is preferable to perform heat treatment to the stretched substrate (A). the temperature for heat treatment is preferably within the range between the stretching temperature and a temperature 30° C. higher than the stretching temperature. Through performing heat treatment, the thermal shrinkage ratio at the stretching direction is reduced, and the tightening during product storage, or the wrinkle caused by heat and contraction during fusing seal, is reduced. The method for heat treatment is typically carried out with a roll and a heat oven, or these may be combined. From the viewpoint of achieving high treatment effect, the heat treatment is preferably carried out in a state that the stretched film is kept in tension.

From the viewpoint that sufficient mechanical strength and rigidity of the label as a support can be readily achieved, the thickness of the substrate (A) in the label is preferably 19.9 μm or more, more preferably 39.5 μm or more. On the other hand, from the viewpoint that the property of shape following against the hollow molded container of the label can be readily achieved, the thickness of the substrate (A) in the label is preferably 230 μm or less, more preferably 190 μm or less.

[Adhesive Layer (B)]

The adhesive layer (B) in the label has a function of adhering to the hollow molded container. The adhesive layer (B) is typically formed through a resin composition wherein thermoplastic resin serves as main component. The thermoplastic resin shows a melting point lower than that of the resin composition constituting the substrate (A).

From the viewpoint that the substrate (A) will not deform when adhere to the hollow molded container, the difference between the melting point of the thermoplastic resin as the main component of the adhesive layer (B) and the melting point of the resin composition that constitutes the substrate (A) is preferably 10° C. or more, more preferably 15° C. or more. On the other hand, from the viewpoint that the labels for forming are not likely to block when stored before adhering to the hollow molded container or processed, and the labels have excellent handling properties, the difference in melting points is preferably 150° C. or less.

As specific examples of the thermoplastic resin used in adhesive layer (B), it may exemplify ultralow-density, low-density or medium-density high-pressure polyethylene, straight-chain linear low density polyethylene, ethylene-vinyl acetate copolymer, ethylene-acrylic acid copolymers, ethylene-alkyl acrylate copolymer where the carbon atom number in the alkyl group is 1˜8, ethylene-alkyl methacrylate copolymer where the carbon atom number in the alkyl group is 1˜8, propylene resins as represented by propylene.α-olefin copolymer; polyester-based resins; styrene-based elastomer resins, polyamide-based resins, and the like. In addition, other well-known additives for resin can be optionally added into the adhesive layer (B), so long as the heat-sealing property is not disrupted. As such additives, for example, it may exemplify a dye, a nucleating agent, a plasticizer, a release agent, a flame retardant, an antioxidant, a photostabilizer, a ultraviolet absorbent and the like.

[Forming of the Adhesive Layer (B)]

The method for forming the adhesive layer (B) as the thermoplastic resin film is not particularly limited; various well-known methods can be used.

As an specific example, the following method is preferable: a co-extrusion casting molding method, where the molten resins of the substrate (A) and the adhesive layer (B) are laminated in the same mold and extruded into a sheet to simultaneously form and laminate two layers, therefore a laminated body is obtained. Further, a method that the molten resin of the adhesive layer (B) is laminated on one side of the substrate (A) obtained above is also preferred. In addition, the laminated sheet obtained may further be stretched along the longitudinal or transverse direction, same as stretching the substrate (A).

From the viewpoint to achieve sufficient adhesive force to the hollow molded container, the thickness of the adhesive layer (B) of the label is preferably 0.1 μm or more, more preferably 0.5 μm or more. On the other hand, from the viewpoint that when performing offset printing at the sheet stage and when the label is inserted into the mold, the label is not likely to curl, the thickness of the adhesive layer (B) of the label is preferably 20 μm or less, more preferably 10 μm or less.

<Hollow Molded Container and Preparation Thereof>

The material constituting the hollow molded container and the molding method for the hollow molded container of the labeled hollow container of the present disclosure are not particularly limited; well-known material and molding method can be used.

[Material of the Container]

As the material for the main body of the labeled hollow molded container, a material that can be formed into a hollow container is used. Thermoplastic resin is typically used, for example, it may exemplify polyethylene terephthalate (PET) and its copolymers, polyolefin resins such as polypropylene (PP), polyethylene (PE), polycarbonate resin and the like. Among these, polyolefin resins are preferably used since they are resins easy for blow molding. In addition, it is preferable to use a thermoplastic resin composition that contains such thermoplastic resin as the main component.

When manufacturing the labeled hollow molded container, a preferred method is that, the label is inserted into the mold, and a thermoplastic resin composition in formable state is introduced into the mold. Therein, the following method is preferred: first a preform or a parison, formed by the resin, are produced in the mold; then they are held with the mold and subjected to blow molding. Through blow molding, the label can be attached to the container when molding the container. Thus, while keeping the appearance design features, light weight and productivity, the labeled hollow molded container can be conveniently produced in a short period of time.

[Installation of the Label in the Mold]

The labeled hollow molded container of the present disclosure is produced as follows: the label is inserted into a mold which has a label loading recess, and thermoplastic resin in molten state is introduced into the mold, then produced. Therein, it can be easily produced through a method that the label is integrated during blow molding.

When the label is installed in the mold, it is preferable to make the direction of the label where the Gurley flexibility is 150˜350 mN be consistent with the vertical direction of the mold. By installing in this way, curling and drooping of the label in the mold due to the weight of the label itself or occurrence of wrinkles may be inhibited. In addition, the label is installed in the mold in such a way that, the label contacts the mold with the side opposite to the adhesive layer. When the label is installed in the mold, suction can be carried out through the hole made in the mold, so as to fix the position of the label.

Further, in order to precisely load the label into the label loading recess, which is provided in the mold and fits the shape of the label, mechanical loading by an inserter is preferred, and for the inserter, an inserter having servomotor with high precision of stroke is preferably used.

As blow molding, the well-known biaxial stretching blow molding method, direct blow molding method and the like may be suitably selected and used. For example, if the labeled container is produced through direct blow molding, a hot parison typically at 150˜240° C., preferably 170˜230° C. is produced, and in a mold typically at 10˜50° C., preferably 20˜40° C., with blow pressure of typically 0.49˜3.92 MPa (5˜40 kg/cm²), preferably 0.98˜2.94 MPa (10˜30 kg/cm²), it is blown for typically 0.5˜10 seconds, preferably 1˜6 seconds, then the labeled hollow molded container of the present disclosure can be produced.

The cross section of the main body of the container is not necessarily perfectly circular, for example, it may also be elliptical or rectangular. When the cross section is rectangular, the corner of the rectangle preferably has curvature. From the viewpoint of strength, the cross section of the main body is preferably a perfect circle or an ellipse close to a perfect circle, and is most preferably a perfect circle.

### EXAMPLES

The Examples and Comparative examples listed below further demonstrate the characteristics of the present disclosure. The material, use amount, ratio, treatment content, treatment procedure, etc., may be appropriately revised without departing from the scope of the present disclosure. Therefore, the scope of the present disclosure is not limited to the specific examples shown below.

[Evaluation Method]

Thickness of the Label:

The thickness of the label was measured based on Method A of JIS K 7130:1999 (“Plastic-film and sheet—thickness measurement method”), using a constant pressure thickness measurement instrument (manufactured by TECLOCK Corporation, machine name: PG-01J).

Basis Weight of the Label:

The basis weight of the label, based on JIS P 8124:1998 (“Paper and paperboard—method for measuring basis weight”), was weighed on an electronic balance, and a sample punched into 100 mm×100 mm size was measured.

Density of the Label:

The density of the label was calculated in the form of a value, which was obtained through dividing the basis weight of the label obtained above by the thickness of the label obtained above. The result is summarized in Table 2.

In addition, the density of the thermoplastic resin used, based on Method A in JIS K 7112:1999 (“Method for measuring density and specific gravity of plastic—non-foamed plastic”), was calculated from a pressed sheet of the thermoplastic resin used using water displacement method.

Compression Ratio of the Label:

The fixture for measuring the compression ratio was constructed as follows.

The experiment stand 9 had a sample table 10 which could bear the measurement sample 8, and a laser displacement sensor head 11 (manufactured by KEYENCE Corporation, product name: LK010). The center of the sample table 10 was hollowed into a circle with a diameter of 20 mm. The laser 13 from laser displacement sensor head 11 irradiated sample clamping fixture 12. The laser reflected by sample clamping fixture 12 again reached the laser displacement sensor head 11 as incident light. The output from the laser displacement sensor head 11 was captured by an amplify unit (not shown in the figure; manufactured by KEYENCE Corporation, product name: LK3100).

A circular sample clamping fixture 12 with a diameter of 50 mm was placed on the measurement sample 8 (sample contact area: 2.5434 cm²), further the fixture 12 was connected to a load sensor 14 of a compression/tensile testing machine (manufactured by Shimadzu Corporation, product name: Autograph AGS-5KND) via a metal ball 15.

When performing measurement, the stress data were imported into the computer with a sampling period of 50 ms from the analog output of the compression/tensile testing machine, meanwhile the displacement data were imported into the computer with a sampling period of 2048 ms from the analog output of the amplify unit.

On the other hand, the labels were cut into 50 mm×50 mm squares, and the centers were hollowed into circles with diameter of 20 mm, so measurement sample 8 (3 samples) were prepared.

First, in the sample clamping fixture 12 shown in FIG. 6, a blank measurement that the displacement was 0 was performed in a state that the sample 8 was not placed.

Then the sample 8 was placed in the sample clamping fixture 12. When the stress was 0 N, the displacement was measured and recorded as the initial film thickness e.

Then stress was applied on the surface of the film at a rate of 1 mm/min by the compression/tensile testing machine. When the pressure at the film surface reached 3.138 MPa (32 kgf/cm²), the stress was released. Then the image obtained from the output from the compression/tensile testing machine and the output from laser displacement sensor in the computer was analyzed, and the displacement at the time that the pressure of the film surface reached 3.138 MPa (32 kgf/cm²) was calculated, recorded as the pressed film thickness f. Then the compression ratio c is calculated through the following formula.

compression ratio c=100×(e−f)/e formula (3)

unit of c: %

unit of e, f: μm.

Label thickness at the labeled part (T), container thickness at the labeled part (Y) and the container thickness at the unlabeled part (Z):

The main body of the container was incised from the labeled hollow molded container in such a manner that the boundary of the label (label edge) was included as the specimen. Then the specimen was chilled to a temperature of −60° C. or lower using liquid nitrogen. A blade (manufactured by Schick Japan K.K., product name: Proline Blade) was subjected to perpendicularly contact with the specimen placed on a glass plate, and the specimen is cut off, so that the specimen for cross section measurement was prepared. The cross section of the specimen obtained was observed with a digital microscope (manufactured by KEYENCE Corporation, machine name: VHX-1000), and the thickness at T, Y and Z part as shown in FIG. 1 was determined. The label thickness at the labeled part (T), the container thickness at the labeled part (Y) and the container thickness at the unlabeled part (Z) were calculated.

It should be noted that, the label thickness at the labeled part (T) and the container thickness at the labeled part (Y) as shown in FIG. 1 were measured at the cross section as indicated above, 1±0.05 mm inward the label boundary 1a along the label surface. In addition, the container thickness at the unlabeled part (Z) was similarly measured at the cross section as indicated above, 1±0.05 mm outward the label boundary 1a along the label surface.

Falling Test of the Labeled Hollow Molded Container:

The formed 3 L labeled hollow molded container was filled with 3 L water, and used as the sample for falling test in a state that the cap was tightly closed. Under an environment of 23° C., four times of falling test were carried out using a falling tester (manufactured by SHINYEI Technology Co., LTD., instrument name: DTS-50), where the sample fell to a concrete floor from a height of 1200 mm. The breakage number of each sample was confirmed, and the samples were evaluated following the criteria below.
Container breakage number 0: ∘ (good)
   1-2: □ (pass)
   3 or more: x (bad)

### Production of the Label

### Production Example 1

As the material for substrate layer (A), the thermoplastic resin (PP-1), inorganic fine powder (CA-1 and TI-1) were mixed according to the blending ratio (by mass) recorded in Table 2. The mixture was fed to an extruder set at 250° C., melt-kneaded in the extruder. The melted resin composition was fed to a T mold set at 250° C., and extruded into a sheet through the T mold. The sheet-like resin composition was cooled to about 60° C. with a cooling roll, and an unstretched sheet was obtained. Then the unstretched sheet was re-heated to 150° C., stretched 4-fold at the longitudinal direction using the peripheral speed difference of a set of rolls, cooled to about 60° C. with a cooling roll, and then a 4-fold stretched sheet was obtained.

On the other hand, as the material for adhesive layer (B), the thermoplastic resin (PE-1) was melt-kneaded with an extruder set at 230° C. Then the melted thermoplastic resin (PE-1) was extruded into a sheet using a T mold set at 230° C. The thermoplastic resin was laminated onto the 4-fold stretched sheet, and introduced to the place between a metal cooling roll shaped with #150 line gravure embossing and a mat-pattern rubber roll in such a manner that the side of the mat-pattern rubber roll contacted with the 4-fold stretched sheet. The thermoplastic resin and the 4-fold stretched sheet jointed through the nipping of the metal cooling roll and the mat-pattern rubber roll, meanwhile embossed pattern was transferred onto the thermoplastic resin side, the sheet was cooled with a cooling roll, then a laminated resin sheet with two-layer structure was obtained.

Then, the laminated resin sheet, after re-heated to 165° C. with a tenter oven, was stretched 9-fold in transverse direction with a tenter, then subjected to annealing treatment using a heat setting zone adjusted to 165° C., cooled to about 60° C. with a cooling roll. The edge part was trimmed, and a biaxially stretched resin film which had a two-layer structure of substrate layer (A)/adhesive layer (B) was obtained, used as the label in Production Example 1.

The production condition and physical properties of the label in Production Example 1 are shown in Table 2.

### Production Example 2˜5

Except that the material of substrate (A) and blending ratio, longitudinal stretching temperature, longitudinal stretching ratio, transverse stretching temperature and transverse stretching temperature in the production of label were changed to the conditions as recorded in Table 2, the labels were produced in a manner same with that in Production Example 1, used as the labels in Production Example 2˜5.

The production condition and physical properties of each label were shown in Table 2.

TABLE 1
Raw material used

| | | | | | | | Crystallization | | |
|---|---|---|---|---|---|---|---|---|---|
| | | | | | | Melt peak | peak | | Volume |
| | | | | | MFR | temperature | temperature | | average |
| | | | | | (JIS K. | (JIS K | (JIS K | | particle |
| Type | No. | Material | Trade name | Manufacturer | 7210: 1999) | 7121: 1987) | 7210: 1999) | Density | diameter |
| Thermo- | PP-1 | propylene | NOVATEC | Japan | 5 g/10 min | 167° C. | — | — | — |
| plastic | | homopolyer | PP MA4 | Polypropylene | | | | | |
| resin | | | | Corporation | | | | | |
| | PE-1 | metallocene | Kernel | Japan | 12 g/10 min | 100° C. | 89° C. | 0.907 g/cm³ | — |
| | | polyethylene | KS571 | Polyethylene | | | | | |
| | | | | Corporation | | | | | |
| | PE-2 | high density | NOVATEC HD | Japan | 0.2 g/10 min | 133° C. | 115° C. | 0.956 g/cm³ | — |
| | | polyethylene | HB420R | Polyethylene | | | | | |
| | | | | Corporation | | | | | |
| Inorganic | CA-1 | heavy calcium | SOFTON | Bihoku Punka | — | — | — | — | 1.8 μm |
| fine powder | | carbonate | #1800 | Kogyo Co., Ltd | | | | | |
| | TI-1 | nitrile | Tipaque | Ishihara Sangyo | — | — | — | — | 0.2 μm |
| | | titanium | CR-60 | Kaisha, Ltd. | | | | | |
| | | dioxide | | | | | | | |

—: no data

TABLE 2
Production Example of the label in the mold

| | | | | | | | | | | physical properties of the label | | | | | |
|---|---|---|---|---|---|---|---|---|---|---|---|---|---|---|---|
| | Production condition | | | | | | | | | thick- | thick- | | | com- | |
| | Substrate (A) | | | | | longitudinal | | transverse | | ness | ness | label | | pres- | |
| | | | | | | stretch | | stretch | | of | of | thick- | | sion | |
| | Thermoplastic | | | | Adhesive | temper- | | temper- | | substrate | adhesive | ness | | ratio | void |
| | resin | | CA-1 | TI-1 | layer | ature | ratio | ature | ratio | (A) | layer (B) | t | density | c | ratio |
| | Type | (wt %) | (wt %) | (wt %) | (B) | (C. °) | (fold) | (C. °) | (fold) | (μm) | (μm) | (μm) | (g/cm³) | (%) | % |
| Production | PP-1 | 89 | 10 | 1 | PE-1 | 150 | 4 | 165 | 9 | 100 | 5 | 105 | 0.78 | 22 | 20.6% |
| Example 1 | | | | | | | | | | | | | | | |
| Production | PP-1 | 69 | 30 | 1 | PE-1 | 140 | 4 | 160 | 9 | 100 | 5 | 105 | 0.50 | 49 | 56.4% |
| Example 2 | | | | | | | | | | | | | | | |
| Production | PP-1 | 69 | 30 | 1 | PE-1 | 140 | 4 | 160 | 9 | 75 | 5 | 80 | 0.50 | 48 | 56.4% |
| Example 3 | | | | | | | | | | | | | | | |
| Production | PP-1 | 75 | 24 | 1 | PE-1 | 140 | 4 | 160 | 9 | 75 | 5 | 80 | 0.69 | 34 | 36.8% |
| Example 4 | | | | | | | | | | | | | | | |
| Production | PE-2 | 29 | 70 | 1 | PE-1 | 95 | 2 | 100 | 2 | 100 | 5 | 105 | 0.66 | 60 | 61.7% |
| Example 5 | | | | | | | | | | | | | | | |

### Production of Labeled Hollow Molded Container

### Example 1

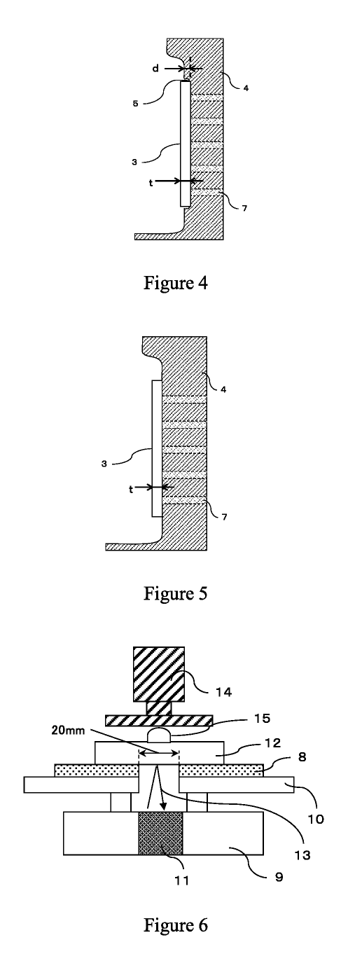

The labels in Production Example 1 were punched into a shape as shown in panel 3, FIG. 3 with defined size (horizontal 110 mm, vertical 171 mm), for producing the labeled hollow molded container. In a mold in which a bottle of 3 L volume may be formed, the label was configured in a manner that the adhesive layer (B) faced the chamber side, and fixed on the mold through suction. At this time, the label loading recess d in the cooling mold as shown in FIG. 4 was set as 100 μm.

Then, as the material for the main body of the hollow molded container, the thermoplastic resin (PE-2) was melted at 170° C., and extruded into a parison form in a mold where the cooling temperature was set at 20° C. Then, after clamping the molds, compressed air of 0.4 MPa (4.2 kg/cm²) was supplied into the parison to expand the parison, and the expanded parison was kept in close contact with the mold for 16 s, so that was produced into the container shape, while fused with the label. Then the formed article was cooled in the mold, the mold was open, and the labeled hollow molded container in Example 1 was obtained.

In Example 1, the shot cycle time was 28 s/time.

In FIG. 3, the sample for measuring the physical properties of the labeled hollow molded container was collected at position 2a.

The forming condition (label, mold) of the labeled hollow molded container and the physical properties of the labeled hollow molded container are shown in Table 3.

### Example 2-6, Comparative Example 1

Except that the label, the setting of the label loading recess d in the cooling mold in Example 1 were changed to the value indicated in Table 3, the procedure same as Example 1 was carried out, then the labeled hollow molded containers in Example 2 and 3 were obtained. The label used for producing the labeled hollow molded container, the condition of mold and the physical properties of the labeled hollow molded container obtained in each Example and Comparative Example are shown in Table 3.

TABLE 3

| | | | | mold | physical properties of the labeled hollow formed container | | | |
|---|---|---|---|---|---|---|---|---|
| | label | | | depth of the | label thickness | variation of | falling test | |
| | | | compression | label loading | at the label | wall | breakage | |
| | | thickness | ratio | gap | bonding part | thickness of | number | |
| | | t | c | d | T | main body | (number/test | decision |
| | Production Example | (μm) | (%) | (μm) | (μm) | (μm) | number) | (∘Δx) |
| Example 1 | Production Example 1 | 105 | 22 | 100 | 98 | 10 | 0/4 | ∘ |
| Example 2 | Production Example 2 | 105 | 49 | 50 | 89 | 10 | 0/4 | ∘ |
| Example 3 | Production Example 2 | 105 | 49 | 0 | 80 | 45 | 1/4 | Δ |
| Example 4 | Production Example 3 | 80 | 48 | 0 | 70 | 32 | 0/4 | ∘ |
| Example 5 | Production Example 4 | 80 | 34 | 0 | 75 | 65 | 2/4 | Δ |
| Example 6 | Production Example 5 | 110 | 60 | 0 | 100 | 32 | 0/4 | ∘ |
| Comparative | Production Example 1 | 105 | 22 | 0 | 90 | 90 | 4/4 | x |
| Example 1 | | | | | | | | |

It can be noted in Table 3 that, in Example 1˜6, where the variation X of the wall thickness of the main body of the cross section of the labeled hollow molded container, which is calculated from observation using optical microscope, satisfies formula (1), the results in the falling test are decided as ∘ level (good) or Δ level, which are fine; on the contrary, in Comparative Example 1, where the variation X of the wall thickness of the main body does not satisfy formula (1), the result is decided as x level (bad) in the falling test.

On the other hand, in Example 1 and 2, where the cooling mold of the hollow molding machine is used and the label inserting section of such mold has a structure that is able to provide a label loading recess which fits the shape of the label, and the depth of the gap satisfies formula (2), the results are decided as ◯ level (good) in the falling test. On the contrary, in Comparative Example 1, where the mold in prior art is used, said mold does not have the gap, that is, d=0 and the formula (2) is not satisfied, the result is decided as x level (bad) in the falling test.

It should be noted that, even in Comparative 1, where the mold in prior art is used and the label compression ratio c at 3.138 MPa is less than 30%, the variation X of the wall thickness of the main body is X=T, which cannot satisfy formula (1), and the result is decided as x level (bad) in the falling test. While in Example 3, where the compression ratio c of the label is 30% or more and 60% or less, the variation X of the wall thickness of the main body satisfies formula (1), and the result is decided as Δ level (pass), and the impact resistance when the container falls is improved.

### INDUSTRIAL APPLICABILITY

The labeled hollow molded container of the present disclosure has favorable impact resistance, and there is a tendency that even the container in a content-filled state falls, it is not susceptible to breakage. Further, even the labeled hollow molded container filled with content is loaded into corrugated cardboard boxes for shipping, then shipped in a state that the corrugated cardboard boxes are stacked as several layers, there is also a tendency that the labeled hollow molded container is not susceptible to breakage. Therefore the labeled hollow molded container is suitable for the purpose to hold a variety of liquids (such as edible oil, liquid seasonings, drinks, alcohols, kitchen cleaners, laundry detergents, shampoo, hair conditioner, liquid soap, alcohol for disinfection, oil for automobile, detergents for automobile, agricultural chemicals, pesticides, herbicides, etc.), and to circulate, exhibit, purchase, store and use such liquids.

In addition, the larger the internal volume of the labeled hollow molded container is, the thinner the container thickness of the labeled hollow molded container is, and the thicker the thickness of the label is, the more significant the effect of favorable impact resistance of the labeled hollow molded container obtained through the present disclosure is.

1. A labeled hollow molded container, comprising a label and a hollow molded container, wherein
the hollow molded container is formed with thermoplastic resin composition, and is obtained by a method of integrating the label while blow molding,
X satisfies following formula (1), and a value of X is 90 or less, where X is a variation of wall thickness of main body of the hollow molded container in a cross section, which is determined by an optical microscope,
−50≦X<T formula (1)
the variation of the wall thickness of the main body: X=Z−Y,
thickness of the label at a labeled part: T,
thickness of the hollow molded container at the labeled part: Y,
thickness of the hollow molded container at an unlabeled part: Z,
unit of X, Y, Z, and T: μm.

2. The labeled hollow molded container according to claim 1, wherein a compression ratio c of the label at a pressure of 3.138 MPa is 30% or more and 60% or less.

3. The labeled hollow molded container according to claim 1, wherein the labeled hollow molded container is molded using a mold with a label inserting section, said label inserting section has such a structure that provides a label loading recess which fits a shape of the label.

4. (canceled)

5. The labeled hollow molded container according to claim 1, wherein the thermoplastic resin composition comprises a polyolefin resin composition.

6. A method for molding a labeled hollow container using a mold, the mold having a label inserting section, said label inserting section having such a structure that provides a label loading recess which fits a shape of a label, the method comprising:
inserting the label into the label inserting section of the mold; and
then introducing a thermoplastic resin composition in a moldable state into the mold to perform a container molding process, wherein d, which is a depth of the label loading recess, satisfies following formula (2),
0<d≦t+50 formula (2)
depth of the label loading recess: d,
thickness of the label: t,
unit of d and t: μm.

7-8. (canceled)

9. A cooling mold of a hollow molding machine, comprising a label inserting section, wherein
the label inserting section has such a structure that provides a label loading recess which fits a shape of a label.

10. The cooling mold according to claim 9, wherein d, which is a depth of the label loading recess, satisfies following formula (2),
0<d≦t+50 formula (2)
depth of the label loading recess: d,
thickness of the label: t,
unit of d and t: μm.
